(19) United States
(12) Patent Application Publication
(10) Pub. No.: US 2026/0065423 A1
(43) Pub. Date: Mar. 5, 2026

(54) METHOD AND APPARATUS FOR GENERATING HIGH-RESOLUTION HUMAN-CENTRIC SCENE USING PRETRAINED DIFFUSION MODEL

(71) Applicant: SEOUL NATIONAL UNIVERSITY R&DB FOUNDATION, Seoul (KR)

(72) Inventors: Se Young CHUN, Seoul (KR); Gwanghyun KIM, Seoul (KR); Hayeon KIM, Seoul (KR); Hoigi SEO, Yongin-si (KR); Dong Un KANG, Seoul (KR)

(73) Assignee: SEOUL NATIONAL UNIVERSITY R&DB FOUNDATION, Seoul (KR)

(21) Appl. No.: 19/019,060

(22) Filed: Jan. 13, 2025

(30) Foreign Application Priority Data
Aug. 28, 2024 (KR) 10-2024-0115484

(51) Int. Cl. G06T 3/4061; G06T 11/00

(52) U.S. Cl. CPC G06T 3/4061; G06T 11/00

(57) ABSTRACT

The present disclosure relates to technology that generates a high-resolution image from a text prompt by applying an adaptive joint diffusion technique to a latent vector injected with high-frequency noise to generate a high-resolution human-centric scene.

### CROSS-REFERENCE TO RELATED APPLICATION(S)

This application claims the benefit under 35 USC 119(a) of Korean Patent Application No. 10-2024-0115484, filed with the Korean Intellectual Property Office on Aug. 28, 2024, the disclosure of which is incorporated herein by reference in its entirety.

### BACKGROUND OF THE INVENTION

### Field of the Invention

The present disclosure relates to technology that generates a high-resolution image from a text prompt by applying an adaptive joint diffusion technique to a latent vector injected with high-frequency noise to generate a high-resolution human-centric scene.

### Background of the Related Art

Technology utilizing a generative model is emerging as a key research topic in the field of computer vision and graphics, and in particular, research on technologies that use a generative model to generate a high-resolution image that faithfully reflects the content of a text prompt is being actively carried out.

The main goal of such a text-to-image conversion model is to generate a scene including the appearance of an object based on a given text description. The text-to-image conversion model may be used in a variety of applications such as animation, gaming, film production, virtual reality, and augmented reality, and focuses on expressing human appearance and posture to make a user's imagined scene more realistic.

Existing text-to-image conversion models have shown relatively high performance in generating single objects or simple scenes. For example, these models are relatively good at expressing a scene that includes a simple pose of a specific character or a simple background, and are mainly used for SNS content generation, advertising design, and simple graphic production.

However, existing technologies have several limitations in generating high-resolution images. In particular, for a prompt including a number of human instances making up a complex scene, resolution is limited and there are often problems with correspondence between text and images. Such limitation is mainly due to the use of models trained at low resolutions, which cause the details of characters to become unnatural or distorted when an image is enlarged to a high resolution.

In addition, existing techniques have difficulties in reflecting all the necessary details in complex scenes due to a limited number of tokens in text encoders. This leads to mismatches between text and images in a complex scene including a number of instances. For example, this leads to problems such as the character's posture, position, and harmony with the background in the scene being expressed unnaturally, and as a result, the generated image often does not match the user's intention.

Therefore, in order to overcome the limitations of the existing technologies, it is required to maintain high resolution and natural text-image correspondence even when including a number of instances in a complex scene, and to accurately implement what the user intends while solving the problem of a limited number of tokens in text encoders.

Such technological improvements may open up new possibilities in various application fields, such as animation, gaming, film production, as well as virtual reality and augmented reality.

### CITATION LIST

### Patent Literature

Korean Patent No. 10-2689642

### Non-Patent Literature

Wang, J., Ghahremani, M., Li, Y., Ommer, B., & Wachinger, C. (2024). Stable-Pose: Leveraging Transformers for Pose-Guided Text-to-Image Generation. arXiv preprint arXiv:2406.02485.

### SUMMARY OF THE INVENTION

An aspect of the present disclosure is to provide a high-resolution human-centric scene generation technology that overcomes an existing limited resolution. In general, text-to-image conversion models are trained at low resolutions, which may lead to a distortion when an image is enlarged to a high resolution. The present disclosure aims to overcome the resolution limitations so as to provide a method capable of generating a natural image while maintaining a high resolution even in a complex human-centric scene.

In addition, the present disclosure aims to solve a problem caused by a limited number of tokens in a text encoder. The limited number of tokens in a text encoder caused mismatch problems between text and images in a complex scene including a number of human instances, resulting in the generation of an outcome that was different from a user's intended scene. The present disclosure aims to solve such a problem of a limited number of tokens, and provide a technology capable of faithfully reflecting all details even in a complex scene.

In addition, the present disclosure aims to prevent the generation of an unrealistic outcome that occurs during a process of generating a high-resolution image. Existing technologies have problems in which a character's pose and background is expressed unnaturally or the quality of an image is degraded during a process of enlarging an image to a high resolution. The present disclosure aims to solve such a problem through high frequency-injected forward diffusion and adaptive joint diffusion techniques, and to propose a method capable of generating a natural image while maintaining accurate correspondence to text even at high resolution.

In conclusion, the present disclosure aims to provide a technical foundation capable of generating a high-resolution natural image as intended by a user even in a complex scene by solving problems such as a limited resolution, a limited number of tokens in text encoders, and a degraded image quality, which are inherent in existing generation techniques. Through this, the present disclosure makes it possible to implement high-quality image generation technology that can be utilized in various fields such as animation, gaming, film production, virtual reality, and augmented reality.

Meanwhile, technical problems of the present disclosure are not limited to the above-mentioned problems, and other technical problems which are not mentioned herein will be clearly understood by those skilled in the art from the description below.

A method of generating, by a processor-driven apparatus, a high-resolution human-centric scene according to one embodiment may include generating a base image based on a text prompt describing an instance and pose information of the instance, and upsampling the base image to a target resolution size; injecting noise into the upsampled image; deriving a first latent vector of a region corresponding to each window while moving a window specifying a portion of an image into which the noise has been injected; generating a second latent vector obtained by reconstructing the first latent vector to a resolution corresponding to the upsampling based on a first text prompt describing an instance included in a window of the first latent vector and first pose information of a region corresponding to the window of the first latent vector; and transforming the second latent vector into an image space to transform into an image of the target resolution.

In addition, the pose information may include at least one of information on coordinates, shapes, and poses at which a plurality of instances are to be located within an image.

In addition, the text prompt may include text describing the characteristics of each of the plurality of instances and index information specifying each of the plurality of instances.

In addition, descriptions for each of the plurality of instances included in the pose information and each of the plurality of instances included in the text prompt may be mapped to each other.

In addition, the injecting of noise may include injecting high-frequency noise into the base image.

In addition, the injecting of high-frequency noise may include recognizing an edge of an instance included in the base image; and swapping the positions of some pixels included within a preset region out of the edge of the instance.

In addition, the injecting of high-frequency noise may include generating a Canny map specifying an edge of an instance included in the upsampled image based on a Canny edge detection technique; applying a Gaussian blur to the Canny map and normalizing values to a range greater than or equal to 0 and less than or equal to 1 to generate a Gaussian probability map C_{i,j} (i, j are indices specifying pixel positions) for each pixel; and mapping a random value greater than or equal to 0 and less than or equal to 1 to each pixel of the upscaled image, comparing the random value mapped to the each pixel with a value C_{i,j} of the probability map for the each pixel to replace a pixel having the random value greater than the value of C_{i,j} with a value of a surrounding pixel.

In addition, the deriving of a first latent vector may include determining an instance included in a window used to derive the first latent vector; and determining a stride at which a window is to be moved based on the type of the determined instance.

In addition, the determining of a stride at which the window is to be moved may include comparing a ratio of a region including a human and a region including a background in a window used to derive the first latent vector to set a narrower stride at which the window is moved as the region including the human is larger than that of the background.

In addition, a size of the window may be determined based on a number of tokens required to use a generative model that reconstructs to a size corresponding to the upsampling from the first latent vector.

In addition, the generating of a second latent vector may include extracting pose information corresponding to a region where a window of the first latent vector is located from among pose information upsampled to the predetermined resolution as the first pose information.

In addition, the transforming to an image of the target resolution may include averaging values of the second latent vector reconstructed in a region where the window of the first latent vector overlaps; and performing decoding to transform the averaged values of the latent vector into an image space in the region where the window overlaps so as to transform the values into the image of the resolution.

In addition, the deriving of a first latent vector may use an encoder of a variational autoencoder, and the deriving of image from a second latent vector may use a decoder of the variational autoencoder.

An apparatus of generating a high-resolution human-centric scene according to one embodiment may include a memory including an instruction; and a processor that performs a predetermined operation based on the instruction, wherein the operation of the processor is configured to generate a base image based on a text prompt describing an instance and pose information of the instance, and upsample the base image to a target resolution size; inject noise into the upsampled image; derive a first latent vector of a region corresponding to each window while moving a window specifying a portion of an image into which the noise has been injected; generate a second latent vector obtained by reconstructing the first latent vector to a resolution corresponding to the upsampling based on a first text prompt describing an instance included in a window of the first latent vector and first pose information of a region corresponding to the window of the first latent vector; and transform the second latent vector into an image space to transform into an image of the target resolution.

A computer program stored on a computer-readable recording medium according to one embodiment may include, when performed on at least one processor, an instruction that allows the processor to generate a base image based on a text prompt describing an instance and pose information of the instance, and upsample the base image to a target resolution size; inject noise into the upsampled image; derive a first latent vector of a region corresponding to each window while moving a window specifying a portion of an image into which the noise has been injected; generate a second latent vector obtained by reconstructing the first latent vector to a resolution corresponding to the upsampling based on a first text prompt describing an instance included in a window of the first latent vector and first pose information of a region corresponding to the window of the first latent vector; and transform the second latent vector into an image space to transform into an image of the target resolution.

The present disclosure may effectively overcome a limited resolution in generating a high-resolution image. The present disclosure proposes high frequency-injected forward diffusion and adaptive joint diffusion techniques to generate natural and detailed images even at high resolution. This may allow users to obtain a more realistic and high-quality image, which may perform an important role in the production of various content such as animation, games, and movies.

In addition, the present disclosure aims to solve a problem of a limited number of tokens in a text encoder so as to provide an advantage capable of faithfully reflecting all details even in a complex scene. In the past, it was difficult to obtain a desired outcome due to mismatches between text and images, but the present disclosure may process a text prompt and perform reconstruction in stages while moving a window of a predetermined size in applying the reconstruction of a generative model, thereby maintaining high correspondence between text and images even in a complex scene including a number of instances. This allows a user to more accurately implement a complex and detailed scene the user wants, and has an effect of increasing usability in various industrial fields.

In addition, the present disclosure has an effect of preventing the degradation of image quality and the generation of an unrealistic outcome that may occur during a process of generating a high-resolution image. The present disclosure may adaptively control a moving stride of a window, which is a unit that performs reconstruction of a latent vector in stages according to the type of an instance included in the window, to adaptively adjust the concentration of reconstruction according to the difficulty or importance of reconstruction of the instance, thereby improving an overall quality of an image and generating a natural image.

In conclusion, the present disclosure may overcome limitations, which are inherent in existing text-to-image conversion models, to maintain high resolution and natural text-image correspondence even when including a number of instances in a complex scene, and to accurately implement what the user intends while solving the problem of a limited number of tokens in text encoders.

Through this, the present disclosure may provide a technical effect capable of generating a high-quality image in various application fields such as animation, gaming, and film production as well as virtual reality and augmented reality.

Meanwhile, the effects of the present disclosure may not be limited to the above-mentioned effects, and other technical effects which are not mentioned herein will be clearly understood by those skilled in the art from the description below.

### BRIEF DESCRIPTION OF THE DRAWINGS

FIG. 1 is a block diagram of a high-resolution human-centric scene generation apparatus according to one embodiment.

FIG. 2 is a flowchart showing steps of operations performed by a high-resolution human-centric scene generation apparatus according to one embodiment.

FIG. 3 is an exemplary diagram for explaining a text prompt, pose information, and a base image according to one embodiment.

FIG. 4 is an exemplary diagram showing an operation of injecting high-frequency noise into an upsampled image according to one embodiment.

FIG. 5 is an exemplary diagram of an operation of deriving, while moving a window specifying a portion of an image into which noise has been injected, a first latent vector of a region corresponding to each window according to one embodiment.

FIG. 6 is an exemplary diagram of an operation of transforming a compressed first latent vector into an image by deriving a second latent vector that is reconstructed to high resolution according to one embodiment.

FIG. 7 is a performance comparison table in which performances of various text-to-image conversion models are compared with one another.

FIG. 8 is a performance comparison table in which, when various generative models generate scenes including multiple instances of characters, performances are compared with one another.

FIG. 9 is an example in which images generated by various generative models and text-to-image conversion models based on a same text prompt.

### DETAILED DESCRIPTION OF THE PREFERRED EMBODIMENT

The details of the objects and technical configurations of the present disclosure and operational effects thereof will be more clearly understood from the following detailed description based on the accompanying drawings appended hereto. Hereinafter, embodiments according to the present disclosure will be described in detail with reference to the accompanying drawings.

Embodiments disclosed herein should not be interpreted as limiting or used to limit the scope of the present disclosure. It is apparent for those skilled in the art that a description including embodiments herein has various applications. Therefore, any embodiments described in the detailed description of the present disclosure are illustrative for better understanding of the present disclosure and are not intended to limit the scope of the present disclosure to the embodiments.

Functional blocks illustrated in the drawings and described hereunder are only examples of possible implementations. In other implementations, other functional blocks may be used without departing from the concept and scope of the detailed description. Furthermore, one or more functional blocks of the present disclosure are illustrated as separate blocks, but one or more of the functional blocks of the present disclosure may be a combination of various hardware and software elements that execute the same function.

In addition, an expression that some elements are “included” is an expression of an “open type”, and the expression simply denotes that the corresponding elements are present, but should not be construed as excluding additional elements.

Moreover, in case where it is mentioned that one element is “connected” or “coupled” to the other element, it should be understood that one element may be directly connected to the other element, but another element may be present therebetween.

Hereinafter, various embodiments of the present disclosure will be described with reference to the accompanying drawings. However, it should be understood that the embodiments are not intended to limit the present disclosure to specific embodiments, and include various modifications, equivalents, and/or alternatives of the embodiments of the present disclosure.

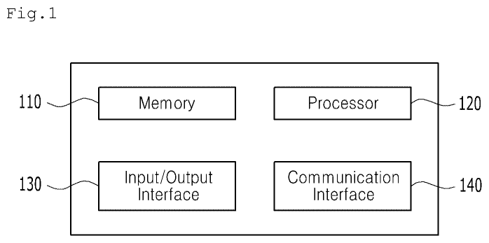

FIG. 1 is a configuration diagram of a high-resolution human-centric scene generation apparatus 100 (hereinafter, referred to as an ‘apparatus 100’) according to one embodiment.

Referring to FIG. 1, the apparatus 100 according to one embodiment may each include a memory 110, a processor 120, an input/output interface 130, and a communication interface 140.

The memory 110 may store data acquired from an external apparatus or data generated by itself. The memory 110 may store instructions that can perform an operation of the processor 120. For example, the memory 110 may store a text prompt, pose information, generative models, and the like, which will be described later.

The processor 120 is an operational apparatus that controls an overall operation. The processor 120 may execute instructions stored in the memory 110. The operation of the apparatus 100 according to an embodiment of the disclosure may be understood as an operation performed by the processor 120.

The input/output interface 130 may include a hardware interface or software interface that inputs and outputs information.

The communication interface 140 allows information to be transmitted and received through a communication network. To this end, the communication interface 140 may include a wireless communication module or a wired communication module.

The apparatus 100 may be implemented as various types of apparatuses capable of performing operations through the processor 120 and transmitting and receiving information through a network. For example, it may be implemented in a form of a server, a computer device, a portable communication apparatus, a smart phone, a portable multimedia apparatus, a laptop, a tablet PC, and the like, but is not limited to those examples.

The apparatus 100 according to an embodiment of the disclosure may improve an image generated by a generative model so as to allow the generative model to generate a higher-resolution image.

Here, the generative model is a neural network model that learns given training data to generate similar data that follows a distribution of the training data. For example, the generative model may receive a text prompt and pose information as input to generate a new image.

The generative model according to an embodiment of the disclosure may include an encoder and a decoder. For example, the generative model may encode input data into a low-dimensional latent vector, and then reconstruct the latent variables to decode high-dimensional data based on information in the input data. That is, the encoder may transform input data such as a text prompt and pose information into a latent vector in a latent space, and the decoder may generate a new image based on the latent vector.

An embodiment of the present disclosure may be applied to various generative models, and in the following embodiments, for convenience of understanding, a variational autoencoder (VAE) is illustrated and described as a generative model.

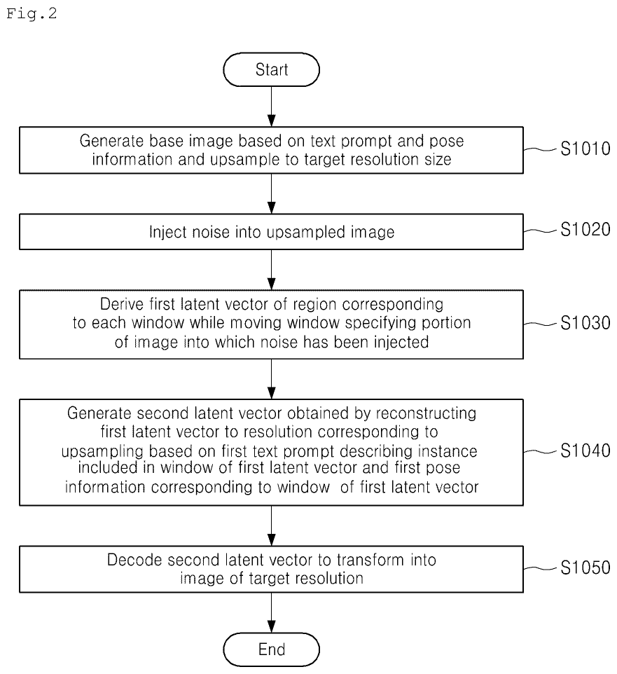

Hereinafter, an embodiment of applying operations of steps S1010 to S1050 to a generative model to generate a high-resolution image will be described with reference to FIGS. 2 to 10.

FIG. 2 is a flowchart of operations performed by the apparatus 100 according to one embodiment. The operation of the apparatus 100 according to an embodiment in FIG. 2 may be understood as an operation performed by the processor 120.

Each step disclosed in FIG. 2 is only a preferred embodiment in achieving the objectives of the present disclosure, and some steps may be added thereto or deleted therefrom as needed, and any one step may be included in another step to be performed. The order of respective operations disclosed in FIG. 2 is only arranged for convenience of understanding, and such an order is not limited to a time series order, and the order may be changed and operated differently depending on the designer's choice.

Referring to FIG. 2, in step S1010, the apparatus 100 may input a text prompt and pose information into a generative model to generate a base image reflecting the text prompt and pose information.

The technique of generating a base image from a text prompt and pose information may be generated using various known techniques, and for example, a pose-guided text-to-image diffusion model may be utilized.

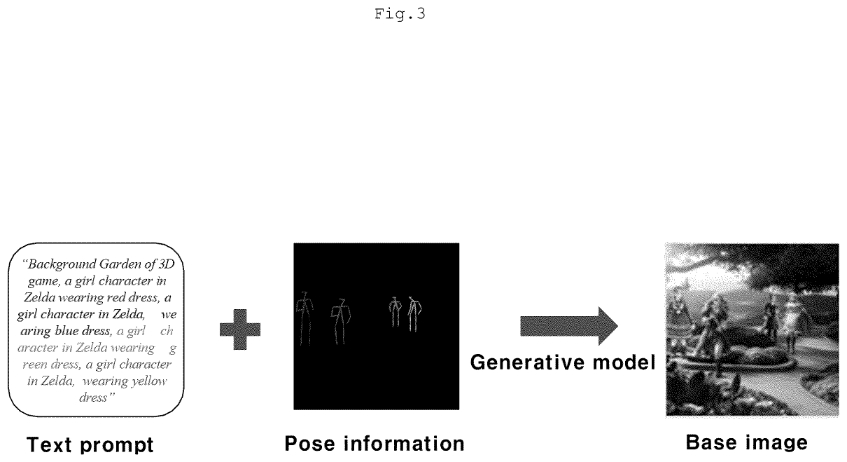

FIG. 3 is an exemplary diagram for explaining a text prompt, pose information, and a base image according to one embodiment.

Referring to FIG. 3, a text prompt is a set of sentences or words used as a starting point for image generation. A text prompt describe the content of an image to be generated (e.g., a description of an instance), and a generative model may determine the composition of the image by referring to the text prompt. For example, a text prompt like “a girl in a red dress” may provide information on the girl's outfit as an instance to be included in an image. A text prompt may describe the characteristics of an instance, a background, a relationship between objects, and the like, and a generative model may interpret them to generate an appropriate image. Here, an instance means a specific object or entity within an image being generated. That is, an instance is an object described by a text prompt, and for example, in the text prompt “a girl in a red dress”, the “girl” is the instance. A text prompt may specify each of a plurality of instances, including a description of each instance. For example, a text prompt could distinguish the description of each instance through index information that specifies each instance.

Pose information is information that defines where an instance is located in an image, what shape it has, and what posture it is in. For example, pose information may include spatial coordinates at which an instance occupies within an image, the posture and shape of the instance (e.g., an angle of an arm, an orientation of a body), and the like. Pose information is used in conjunction with a text prompt to allow a generative model to generate an image that accurately reflects the position and pose of an instance.

A base image is an initial image generated based on a text prompt and pose information, and refers to a basic image for developing into a high-resolution image targeted by the present disclosure through operations S1020 to S1050, which will be described later. For example, if a high resolution targeted by the present disclosure is a 4K image, and a base image may be a 1K image.

In addition, in step S1010, the apparatus 100 may upsample or upscale (hereinafter, collectively referred to as ‘upsampling’) a base image by adding pixels to the base image to increase a resolution of the base image by a target resolution size. Since an upsampled image simply has additional pixels added to increase a size of the base image to a target high-resolution size, there is no real improvement in quality yet. The apparatus 100 improves the quality of an upsampled image through the following operations of S1020 to S1050.

In step S1020, the apparatus 100 may inject noise into the upsampled image. When the upsampled image is used as it is for reconstruction of a generative model, there is a possibility that the generative model reconstructs the upsampled image without recognizing that the quality of the upsampled image is low, and therefore, noise is added to the upsampled image to allow the generative model to generate an image with a higher resolution.

As an example, the apparatus 100 may inject high-frequency noise into pixels of the upsampled image. In this case, when noise is also applied to an edge portion of an instance in the upsampled image, a distinction between the instance and the background becomes ambiguous, which may result in a decrease in reconstruction quality, and therefore, the apparatus 100 may recognize an edge of an instance, distinguish an inside of the instance and the background based on the edge of the instance, and inject high-frequency noise by swapping the positions of some pixels included in the inside of the instance excluding the edge of the instance.

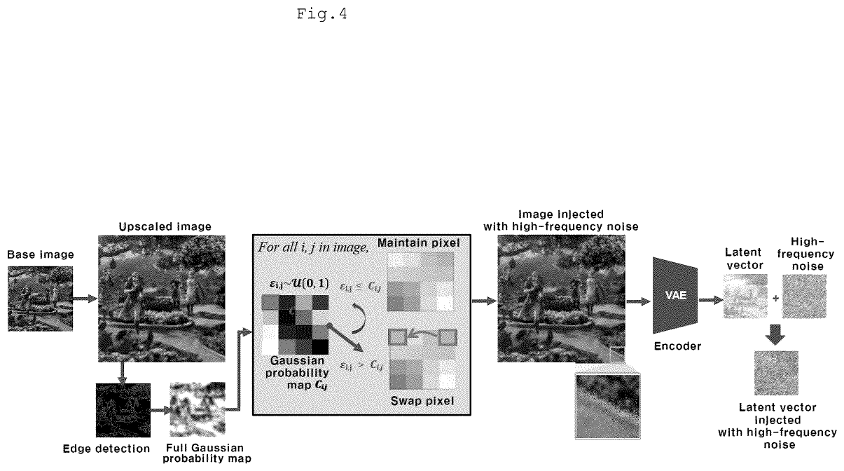

FIG. 4 is an exemplary diagram showing an operation of injecting high-frequency noise into an upsampled image according to one embodiment.

Referring to FIG. 4, the apparatus 100 may recognize an important edge region within an image using a Canny edge detection technique, apply less perturbation to a pixel near the edge, and replace a pixel outside the edge with a value of a surrounding pixel.

To this end, the apparatus 100 may generate a Canny map specifying an edge of an instance included in an upsampled image based on the Canny edge detection technique. Then, the apparatus 100 may normalize an output value of each pixel to which a Gaussian blur is applied to the Canny map to a range greater than or equal to each pixel 0 and less than or equal to 1 to generate a Gaussian probability map C_{i,j} (i, j are indices specifying pixel positions) for each pixel. In addition, the apparatus 100 may map a random value greater than or equal to 0 and less than or equal to 1 to each pixel of the upscaled image, and compare the random value mapped to the each pixel with a value C_{i,j} of the probability map for the each pixel to replace a pixel having the random value greater than the value of C_{i,j} with a value of a surrounding pixel. For example, for a pixel having a random value greater than the value of C_{i,j} for a first pixel, the apparatus 100 may replace the pixel value of the first pixel with a pixel value of a pixel located four pixels away from the first pixel. For example, for a pixel having a random value less than or equal to the value of C_{i,j} for a second pixel, the apparatus 100 may maintain the same pixel value of the second pixel.

That is, the higher the value of C_{i,j} (=the closer the pixel is to an edge or important portion), the more likely it is that the pixel remains the same without adding noise. In contrast, the lower the value of C_{i,j}, the more likely it is that the pixel is replaced with a value of a surrounding pixel, adding high-frequency noise.

Accordingly, the apparatus 100 may generate an image injected with high-frequency noise by swapping positions of some pixels included inside an instance excluding an edge of the instance. The apparatus 100 may input an image injected with high-frequency noise into an encoder of a variational autoencoder to derive a latent vector of the image injected with high-frequency noise.

Here, a latent vector is a representation that compresses high-dimensional data into a low-dimensional space through an encoder of a generative model. For example, a latent vector is a concise representation of complex data such as an image and text in a latent space, and is used by a model to understand and generate data. A latent vector contains an important feature of an original data, which may be utilized to reconstruct the original data or generate new data.

In step S1030, the apparatus 100 may derive a first latent vector encoded with a region corresponding to each window while moving a window specifying a portion of an image into which noise has been injected.

Here, the window is an observation region of a predetermined size, which moves within the image into which noise has been injected and is a unit that extracts the first latent vector through the encoder at each position.

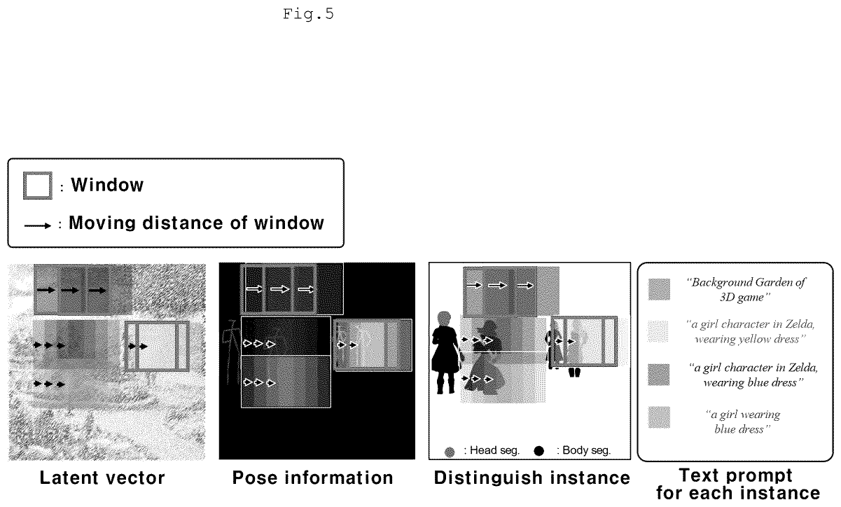

FIG. 5 is an exemplary diagram of an operation of deriving, while moving a window specifying a portion of an image into which noise has been injected, a first latent vector of a region corresponding to each window according to one embodiment.

Referring to FIG. 5, the apparatus 100 may determine an instance included in a window used to derive a first latent vector, and determine a stride to move the window based on the type of the determined instance. A moving stride of a window may be adjusted depending on the type of instance. The apparatus 100 may move the window to a smaller stride in a region including many instances of types that are specifically desired to be embodied within the image to more accurately capture details of those instances.

For example, it is assumed that the goal is to embody the appearance of a ‘human’. In this case, the apparatus 100 may generate a first latent vector while moving a window, and when a ‘human’ is included in the window during the moving of the window, a moving stride of the window may be reduced compared to when only a ‘background’ is included in the window. In addition, the apparatus 100 may compare a ratio of a region including a human and a region including a background in a window used to derive a first latent vector to set a narrower stride at which the window is moved as the region including the human is larger than that of the background.

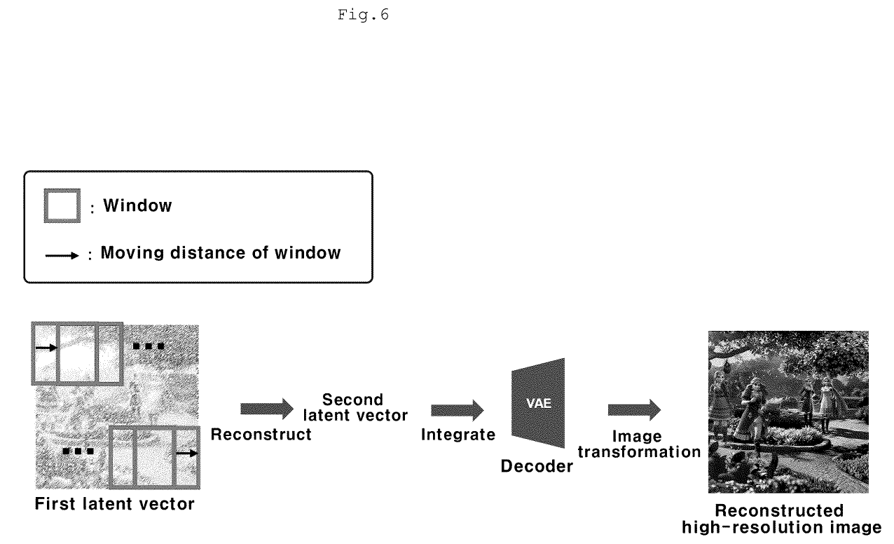

That is, when the window includes a ‘human’, a moving stride of the window may be reduced such that a latent vector can compress information on the human in more detail, thereby allowing the apparatus 100 to generate a first latent vector multiple times even for an overlapping region, and then reconstruct and integrate the overlapping region in step S1040 as shown in FIG. 6.

FIG. 6 is an exemplary diagram of an operation of transforming a compressed first latent vector into an image by deriving a second latent vector that is reconstructed to high resolution according to one embodiment.

Referring to FIG. 6, in step S1040, the apparatus 100 may reconstruct, based on a first text prompt describing an instance included in a window used to extract a first latent vector, and first pose information corresponding to a position of the window used to extract the first latent vector among the pose information, the first latent vector to a resolution corresponding to the upsampling in step S1010 to generate a second latent vector. That is, the second latent vector may include vector information transformed to high resolution from the first latent vector by referring to the first text prompt and the first pose information.

As an example, the first text prompt may include a text prompt mapped to index information specifying an instance included in a window used to derive the first latent vector.

As an example, the first pose information may include pose information corresponding to a region where the window of the first latent vector is located among the pose information corresponding to a size of the image into which noise has been injected. To this end, the apparatus 100 may upsample pose information to the resolution of S1010 to correspond the pose information to the size of the image into which noise has been injected and extract a region corresponding to the first pose information.

Again, referring to FIG. 6, in step S1050, the apparatus 100 may perform decoding to transform the integrated second latent vector into an image space so as to transform into an image of the intended resolution in step S1010.

To this end, the apparatus 100 may obtain an average of values of the second latent vector reconstructed in a region where the window of the first latent vector overlapped as the window is moved in step S1030. Accordingly, the device 100 may perform decoding to transform the values of the second latent vector, in which averaging is performed in the region where the window of the first latent vector overlapped, into an image space so as to generate an image of a final target resolution.

That is, according to steps S1030 to S1050 described above, an embodiment of the disclosure may divide an image injected with noise into window units in step S1030 and perform encoding to generate a plurality of first latent vectors, and reconstruct second latent vectors from the first latent vectors of the window size in step S1040 so as to faithfully reconstruct the second latent vectors without limitation on a number of tokens. Accordingly, in step S1050, the second latent vectors are integrated in the region where the window overlapped while moving so as to reconstruct important parts (e.g., human instances) in more detail. Through window segmentation and adaptive moving techniques, an embodiment of the present disclosure may generate a high-resolution image while solving a low-quality problem caused by a limited number of tokens.

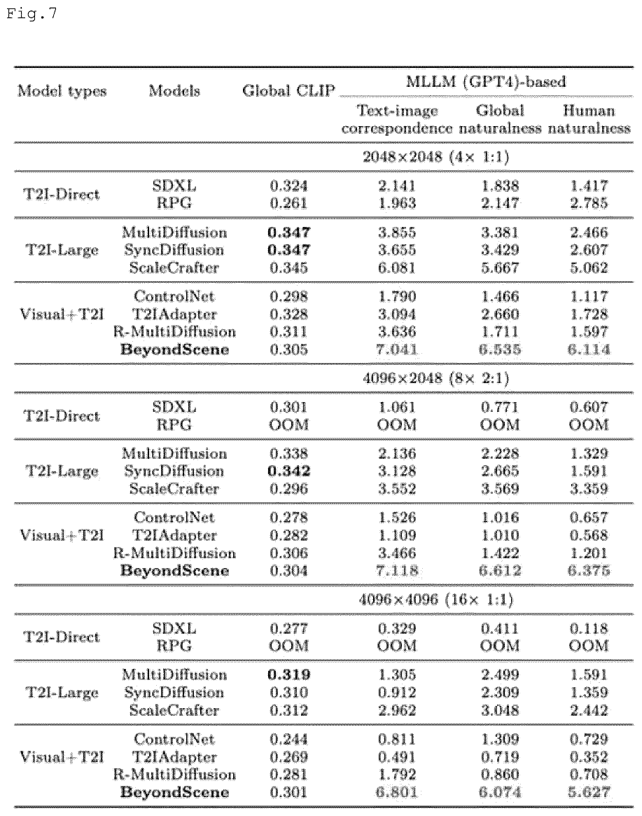

FIG. 7 is a performance comparison table in which performances of various text-to-image conversion models are compared with one another. FIG. 7 shows scores for a match between text and image (global CLIP score), a text-image correspondence, global naturalness of an image, and human naturalness, which is a GPT-4-based evaluation index, when a text prompt is input for various generative models.

FIG. 7 is a performance comparison table in which performances of various text-to-image conversion models are compared with one another. FIG. 7 shows scores for a match between text and image (global CLIP score), a text-image correspondence, which is a GPT-4-based evaluation index, a naturalness of an image, and a naturalness based on a human evaluation, when a text prompt is input for various generative models.

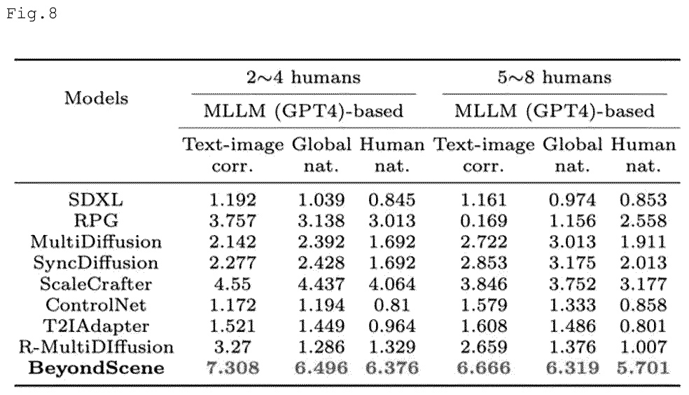

Referring to FIG. 7, it can be seen that the “BeyondScene” model corresponding to an embodiment of the present disclosure shows particularly excellent performance at various resolutions (2048×2048, 4096×2048, 4096×4096). In particular, an embodiment of the present disclosure scored high in evaluations for a text-image correspondence, a naturalness of an image, and a naturalness based on a human evaluation. In conclusion, FIG. 8 is a performance comparison table in which, when various generative models generate scenes including multiple instances of characters (2 to 4 persons, 5 to 8 persons), performances are compared with one another.

FIG. 8 shows scores for a text-image correspondence, a global naturalness of an image, and a human naturalness.

Referring to FIG. 8, it can be seen that the “BeyondScene” model corresponding to an embodiment of the present disclosure shows significantly higher performance than other models in human evaluation scores for a text-image correspondence, a global naturalness of an image, and a human naturalness in both cases (2 to 4 persons, 5 to 8 persons).

Referring to FIGS. 7 and 8, the embodiment of the present disclosure shows excellent performance overall in various evaluation criteria, thereby suggesting that it is very effective in text-to-image conversion tasks.

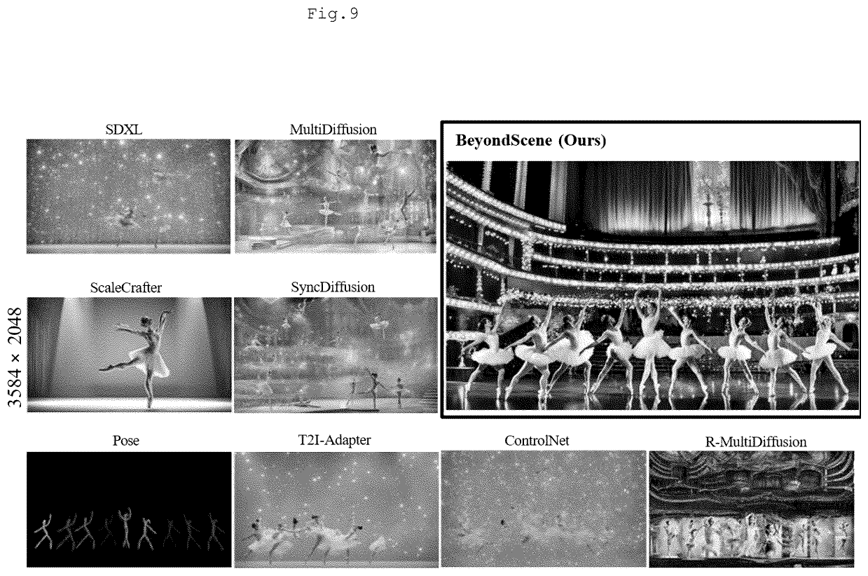

FIG. 9 is an example in which images generated by various generative models and text-to-image conversion models based on a same text prompt.

The text prompt applied to FIG. 9 describes a scene where ballerinas, respectively wearing ballet tutus in different colors, are performing a ballet on the stage of an opera house. An actual example of the text prompt applied to FIG. 9 is shown below.

“Text Prompt: In the background of the empty stage in opera house, there are a dancer in a (Upper) pink ballet suit is doing ballet with sparkling cubics and silver accessories a dancer in a light blue ballet suit is doing ballet. with sparkling cubics and silver accessories a dancer in a pink ballet suit is doing ballet with sparkling cubics and silver accessories a dancer in a light blue ballet suit is doing ballet. with sparkling cubics and silver accessories a dancer in a yellow ballet suit is doing ballet. wearing big silver tiara on her head with sparkling cubics, silver accessories and necklace a dancer in a light blue ballet suit is doing ballet. with sparkling cubics and silver accessories a dancer in a pink ballet suit is doing ballet with sparkling cubics and silver accessories a dancer in a light blue ballet suit is doing ballet. with sparkling cubics and silver accessories a dancer in a pink ballet suit is doing ballet with sparkling cubics and silver accessories.”

Referring to FIG. 9, it can be seen that an image generated by the BeyondScene model, which is an embodiment of the present disclosure, among outcomes generated by various models, accurately reflects the text prompt, generating a very natural and realistic scene, including the stage of the opera house, ballet tutus in various colors, and postures of respective ballerinas. In contrast, the outcomes of the other models show problems such as a lack of background detail, unnatural ballerina poses, and distorted colors. For example, it can be seen that for ControlNet and R-MultiDiffusion, the background did not sufficiently reflect the text prompt, and for MultiDiffusion and T21-Adapter, the ballerina's appearance was rendered unnaturally. According to the comparison in FIG. 9, it can be seen that the BeyondScene model according to an embodiment of the present disclosure accurately reflects the details of the text prompt and is superior to the other models in generating high-quality images.

According to the foregoing embodiment, the present disclosure may effectively overcome a limited resolution in generating a high-resolution image. The present disclosure proposes high frequency-injected forward diffusion and adaptive joint diffusion techniques to generate natural and detailed images even at high resolution. This may allow users to obtain a more realistic and high-quality image, which may perform an important role in the production of various content such as animation, games, and movies.

In addition, the present disclosure aims to solve a problem of a limited number of tokens in a text encoder so as to provide an advantage capable of faithfully reflecting all details even in a complex scene. In the past, it was difficult to obtain a desired outcome due to mismatches between text and images, but the present disclosure may process a text prompt and perform reconstruction in stages while moving a window of a predetermined size in applying the reconstruction of a generative model, thereby maintaining high correspondence between text and images even in a complex scene including a number of instances. This allows a user to more accurately implement a complex and detailed scene he or she wants, and has an effect of increasing usability in various industrial fields.

In addition, the present disclosure has an effect of preventing the degradation of image quality and the generation of an unrealistic outcome that may occur during a process of generating a high-resolution image. The present disclosure may adaptively control a moving stride of a window, which is a unit that performs reconstruction of a latent vector in stages according to the type of an instance included in the window, to adaptively adjust the concentration of reconstruction according to the difficulty or importance of reconstruction of the instance, thereby improving an overall quality of an image and generating a natural image.

In conclusion, the present disclosure may overcome limitations, which are inherent in existing text-to-image conversion models, to maintain high resolution and natural text-image correspondence even when including a number of instances in a complex scene, and to accurately implement what the user intends while solving the problem of a limited number of tokens in text encoders.

Through this, the present disclosure may provide a technical effect capable of generating a high-quality image in various application fields such as animation, gaming, and film production as well as virtual reality and augmented reality.

It should be understood that various embodiments of the disclosure and terms used herein are not intended to limit the technical features described in the disclosure to specific embodiments, and include various modifications, equivalents, or alternatives of the embodiments. With regard to the description of the drawings, similar reference numerals may be used for similar or related elements. A singular form of a noun corresponding to an item may include one or more of the things, unless the relevant context clearly indicates otherwise.

In the disclosure, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. Terms such as “1st”, “2nd”, or “first” and “second” may be used merely to differentiate a corresponding element from another, and do not limit the elements in any other aspect (e.g., importance or order). When an element (e.g., a first element) is referred to as being “coupled” or “connected” to another element (e.g., a second element), with or without the term “functionally” or “communicatively,” it means that the element may be connected to the other element directly (e.g., in a wired manner), in a wireless manner, or through a third element.

The term “module” as used in the disclosure may include a unit implemented in hardware, software or firmware, and may be used interchangeably with terms such as logic, logic block, component, or circuit. A module may be an integrally configured component or a minimum unit of the component that performs one or more functions or a part thereof. For example, according to one embodiment, the module may be implemented in a form of an application-specific integrated circuit (ASIC).

Various embodiments of the disclosure may be implemented as software (e.g., a program) including one or more instructions stored in a storage medium (e.g., a memory) that is readable by a device (e.g., an electronic apparatus). The storage medium may include a random access memory (RAM), a memory buffer, a hard drive, a database, an erasable programmable read-only memory (EPROM), an electrically erasable read-only memory (EEPROM), a read-only memory (ROM), and/or the like.

In addition, a processor in embodiments of the disclosure may retrieve at least one instruction from among one or more instructions stored from a storage medium and execute the retrieved instruction. This allows the device to operate to perform at least one function according to the retrieved at least one instruction. The one or more instructions may include a code generated by a compiler or a code executable by an interpreter. The processor may be a general purpose processor, a field programmable gate array (FPGA), an application specific integrated circuit (ASIC), a digital signal processor (DSP), and/or the like.

The device-readable storage medium may be provided in a form of a non-transitory storage medium. Here, the term ‘non-transitory’ simply means that the storage medium is a tangible apparatus and does not include a signal (e.g. electromagnetic waves), and this term does not differentiate between a case where data is stored semi-permanently and a case where the data is temporarily on the storage medium.

A method according to various embodiments disclosed in the disclosure may be included and provided in a computer program product. The computer program product may be traded as a commodity between a seller and a buyer. The computer program product may be distributed in a form of a device-readable storage medium (e.g., compact disc read only memory (CD-ROM)), or be distributed (e.g., downloaded or uploaded) online via an application store (e.g., PlayStore) or directly between two user apparatuses (e.g., smartphones). In the case of online distribution, at least part of the computer program product may be at least temporarily stored or temporarily generated in the device-readable storage medium, such as a manufacturer's server, a server of an application store, or a server's memory.

According to various embodiments, each element (e.g., a module or a program) of the above-described elements may include a single entity or a plurality of entities. According to various embodiments, one or more of the aforementioned elements or operations may be omitted, or one or more other elements or operations may be added. Alternatively or additionally, the plurality of elements (e.g., modules or programs) may be integrated into a single element. In such a case, the integrated element may perform one or more functions of each of the plurality of elements in the same or similar manner to those performed by a corresponding one of the plurality of elements prior to the integration. According to various embodiments, operations performed by a module, a program or another element may be executed sequentially, in parallel, repeatedly, or heuristically, or one or more of the operations may be executed in a different order, omitted, or one or more other operations may be added.

### DESCRIPTION OF SYMBOLS

100: Apparatus
110: Memory
120: Processor
130: Input/output interface
140: Communication interface

What is claimed is:

1. A method of generating, by a processor-driven apparatus, a high-resolution human-centric scene, the method comprising:
generating a base image based on a text prompt describing an instance and pose information of the instance, and upsampling the base image to a target resolution size;
injecting noise into the upsampled image;
deriving a first latent vector of a region corresponding to each window while moving a window specifying a portion of an image into which the noise has been injected;
generating a second latent vector obtained by reconstructing the first latent vector to a resolution corresponding to the upsampling based on a first text prompt describing an instance included in a window of the first latent vector and first pose information of a region corresponding to the window of the first latent vector; and
transforming the second latent vector into an image space to transform into an image of the target resolution.

2. The method of claim 1, wherein the pose information comprises:
at least one of information on coordinates, shapes, and poses at which a plurality of instances are to be located within an image.

3. The method of claim 2, wherein the text prompt comprises:
text describing the characteristics of each of the plurality of instances and index information specifying each of the plurality of instances.

4. The method of claim 3, wherein descriptions for each of the plurality of instances included in the pose information and each of the plurality of instances included in the text prompt are mapped to each other.

5. The method of claim 1, wherein the injecting of noise comprises:
injecting high-frequency noise into the base image.

6. The method of claim 5, wherein the injecting of high-frequency noise comprises:
recognizing an edge of an instance included in the base image; and
swapping the positions of some pixels included within a preset region out of the edge of the instance.

7. The method of claim 5, wherein the injecting of high-frequency noise comprises:
generating a Canny map specifying an edge of an instance included in the upsampled image based on a Canny edge detection technique;
applying a Gaussian blur to the Canny map and normalizing values to a range greater than or equal to 0 and less than or equal to 1 to generate a Gaussian probability map C_{i,j} (i, j are indices specifying pixel positions) for each pixel; and
mapping a random value greater than or equal to 0 and less than or equal to 1 to each pixel of the upscaled image, comparing the random value mapped to the each pixel with a value C_{i,j} of the probability map for the each pixel to replace a pixel having the random value greater than the value of C_{i,j} with a value of a surrounding pixel.

8. The method of claim 1, wherein the deriving of a first latent vector comprises:
determining an instance included in a window used to derive the first latent vector; and
determining a stride at which a window is to be moved based on the type of the determined instance.

9. The method of claim 1, wherein the determining of a stride at which the window is to be moved comprises:
comparing a ratio of a region including a human and a region including a background in a window used to derive the first latent vector to set a narrower stride at which the window is moved as the region including the human is larger than that of the background.

10. The method of claim 1, wherein a size of the window is determined based on a number of tokens required to use a generative model that reconstructs to a size corresponding to the upsampling from the first latent vector.

11. The method of claim 1, wherein the generating of a second latent vector comprises:
extracting pose information corresponding to a region where a window of the first latent vector is located from among pose information upsampled to the predetermined resolution as the first pose information.

12. The method of claim 1, wherein the transforming to an image of the target resolution comprises:
averaging values of the second latent vector reconstructed in a region where the window of the first latent vector overlaps; and
performing decoding to transform the averaged values of the latent vector into an image space in the region where the window overlaps so as to transform the values into the image of the resolution.

13. The method of claim 1, wherein the deriving of a first latent vector uses an encoder of a variational autoencoder, and
wherein the generating of a second latent vector may use a decoder of the variational autoencoder.

14. An apparatus of generating a high-resolution human-centric scene, the apparatus comprising:
a memory including an instruction; and
a processor that performs a predetermined operation based on the instruction,
wherein the operation of the processor is configured to:
generate a base image based on a text prompt describing an instance and pose information of the instance, and upsample the base image to a target resolution size;
inject noise into the upsampled image;
derive a first latent vector of a region corresponding to each window while moving a window specifying a portion of an image into which the noise has been injected;
generate a second latent vector obtained by reconstructing the first latent vector to a resolution corresponding to the upsampling based on a first text prompt describing an instance included in a window of the first latent vector and first pose information of a region corresponding to the window of the first latent vector; and
transform the second latent vector into an image space to transform into an image of the target resolution.

15. A computer program stored on a computer-readable recording medium, the computer program comprising:
when performed on at least one processor,
an instruction that allows the processor to:
generate a base image based on a text prompt describing an instance and pose information of the instance, and upsample the base image to a target resolution size;
inject noise into the upsampled image;
derive a first latent vector of a region corresponding to each window while moving a window specifying a portion of an image into which the noise has been injected;
generate a second latent vector obtained by reconstructing the first latent vector to a resolution corresponding to the upsampling based on a first text prompt describing an instance included in a window of the first latent vector and first pose information of a region corresponding to the window of the first latent vector; and
transform the second latent vector into an image space to transform into an image of the target resolution.
